(19) United States
(12) Patent Application Publication
(10) Pub. No.: US 2010/0250195 A1
(43) Pub. Date: Sep. 30, 2010

(54) Systems and Methods for Providing Dynamic Segmental Signal Analysis

(75) Inventors: Michael Lee Whaley, Bozeman, MT (US); John Wesley Grant, Gardnerville, NV (US); Olga Malakhova, Minden, NV (US); Brian F. Howard, Issaquah, WA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 12/509,815

(22) Filed: Jul. 27, 2009

Related U.S. Application Data
(60) Provisional application No. 61/164,267, filed on Mar. 27, 2009.

(51) Int. Cl. G06F 15/00

(52) U.S. Cl. 702/183; 702/189

(57) ABSTRACT

Embodiments of the invention include systems and methods for providing dynamic segmental signal analysis. According to one embodiment, a method can include acquiring a first signal array and a second signal array, defining at least one event characteristic corresponding to the first signal array, and identifying at least one index in the first signal array that displays the event characteristic. The method can further include analyzing at least one segment from the second signal array corresponding to the index identified in the first signal array, and determining that at least one system condition exists based on analyzing the segment.

### CROSS-REFERENCE TO RELATED APPLICATIONS

The present application claims priority to U.S. Provisional Application No. 61/164,267 entitled “Systems and Methods for Providing Dynamic Segmental Signal Analysis” filed on Mar. 27, 2009, which is incorporated herein by reference in its entirety.

### FIELD OF THE INVENTION

Embodiments of the invention relate generally to plant and/or machine diagnosis and analysis systems, and more specifically relate to systems and methods for providing dynamic segmental signal analysis.

### BACKGROUND OF THE INVENTION

Plants containing a variety of machine components are monitored to determine machine health and to control plant operations and/or specific machines. The plant and machines being monitored can change in condition, which in turn alters the component behavior and measured or modeled signals representing that behavior. The plant environment may also alter the component operating behavior. Conventional diagnostic systems and methods do not adequately and efficiently account for changes in machine and/or environment without requiring significant reprogramming or programming in a vast number of conditions and exceptions.

Accordingly, there exists a need to dynamically account for machine conditions and/or operating environment when monitoring machine components and performing diagnostic analysis. There further exists a need for system and methods that provide dynamic segmental analysis when performing diagnostic processing.

### BRIEF DESCRIPTION OF THE INVENTION

Embodiments of the invention can address some or all of the needs addressed above. According to one embodiment, a method for diagnosing system conditions is provided. The method can include acquiring a first signal array and a second signal array. The method can further include defining at least one event characteristic, identifying at least one index in the first signal array corresponding to the event characteristic, and defining at least one tracking band based at least in part on the index. The method can further include extracting at least one segment array from the second signal array corresponding to the tracking band, analyzing the segment array extracted from the second signal array, and providing the results of the analysis.

According to another embodiment, a diagnostic system is provided. The system can include a memory, at least one communications interface operable for receiving signal data, and at least one processor in communication with the memory and the communications interface. The processor can be operable to access the memory to execute the computer-executable instructions to acquire a first signal array and a second signal array, to define at least one event characteristic, and to identify at least one index in the first signal array corresponding to the event characteristic. The processor can also be operable to execute the computer-executable instructions to define at least one tracking band based at least in part on the identified index, to extract at least one segment array from the second signal array corresponding to the tracking band, and to analyze the at least one segment array extracted from the second signal array.

According to yet another embodiment, a diagnosing system is provided. The system can include a memory, at least one communications interface operable for receiving signal data, and at least one processor in communication with the memory and the communications interface. The processor can be operable to access the memory to execute the computer-executable instructions to acquire a first signal array and a second signal array, define at least one event characteristic corresponding to the first signal array, and identify at least one index in the first signal array that displays the event characteristic. The processor can further be operable to analyze at least one segment from the second signal array corresponding to the index identified in the first signal array, and determine that at least one system condition exists based on analyzing the segment.

Other embodiments, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is a flowchart illustrating an example method, according to an embodiment of the invention.

FIG. 2 is a flowchart illustrating an example method, according to an embodiment of the invention.

FIG. 3 is a flowchart illustrating an example method, according to an embodiment of the invention.

FIG. 4 is a flowchart illustrating an example method, according to an embodiment of the invention.

FIG. 5 is a flowchart illustrating an example method, according to an embodiment of the invention.

FIG. 6 is a block diagram illustrating an example diagnostic system, according to an embodiment of the invention.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Disclosed are systems and methods for providing dynamic segmental signal analysis. According to various embodiments, methods and systems are provided that can: identify an event or aspect of interest indicated in a signal (which may be referred to herein, and in the incorporated provisional application, interchangeably as a “significant event,” a “monitored event,” or simply an “event”), such as in a signal associated with plant control operations; determine which segments of the signal indicate the significant even or aspects of interest; and index the same or similar areas in a second signal to be analyzed. This may be beneficial in circumstances when events are not as easily identified in the second signal type. Various events may reflect component failures, machine behavior, or other machine conditions desired to be monitored. For example, a first signal is converted into an array, whereby each element of the array is a segment or sample of the original signal and is assigned an index number. Upon converting the signal into the array, the diagnostic system can be configured to identify whether a given event occurs in the array, and if so at which index or indices the event occurs. After having defined the index or indices at which the event in question occurs, a tracking band associated with the index or indices can be defined. A tracking band can include one or more data index values that can be used to identify the similar event in a second signal, or at least the portion of the second signal that may correspond to the event identified in the first signal, for further analysis. For example, the tracking band may be a certain number of data elements at or near the index or indices identified in the first signal indicating the event, such as the identified index plus or minus a predefined (statically or dynamically determined) number of array elements. Once a tracking band is identified, a second signal waveform can be analyzed by converting that second signal into an array and extracting the array segments corresponding to the tracking band as identified in the first array for further analysis as desired for a given plant control and diagnostic inquiry.

Accordingly, by analyzing a first signal with certain identifiable characteristics at known events that are of interest during plant operations and/or diagnosis, a second signal can be analyzed to identify behavior or characteristics indicated in the second signal occurring in association with the events of the first signal. The first, second, and/or any subsequent signals can be synchronous in time and/or synchronized to a portion of a cycle in relation to each signal. As used herein, the term “second signal” may refer to any signal subsequent and/or different from the first or starting signal, and is not limited only to the signal immediately following the first. Being able to segment a signal based on behavior surrounding known events permits applying the same or similar segmentation to other signals, such as those for which events or identifying characteristics are more difficult to discern, for example. Moreover, by identifying the segment in an actual signal representative of machine behavior at or near the time during which the event of interest occurs, these diagnostic methods can account for changes in system behavior and/or operation. Thus, these systems and methods provide the ability to dynamically identify the segment of the actual signal that is indicative of the event of interest, as compared to conventional systems that statically analyze signals and cannot account for the likely changes in system behavior, which likely causes changes in signal behavior. Conventional systems thus have to gather large sample sizes and analyze larger sets of data, increasing the computational complexity and processing overhead.

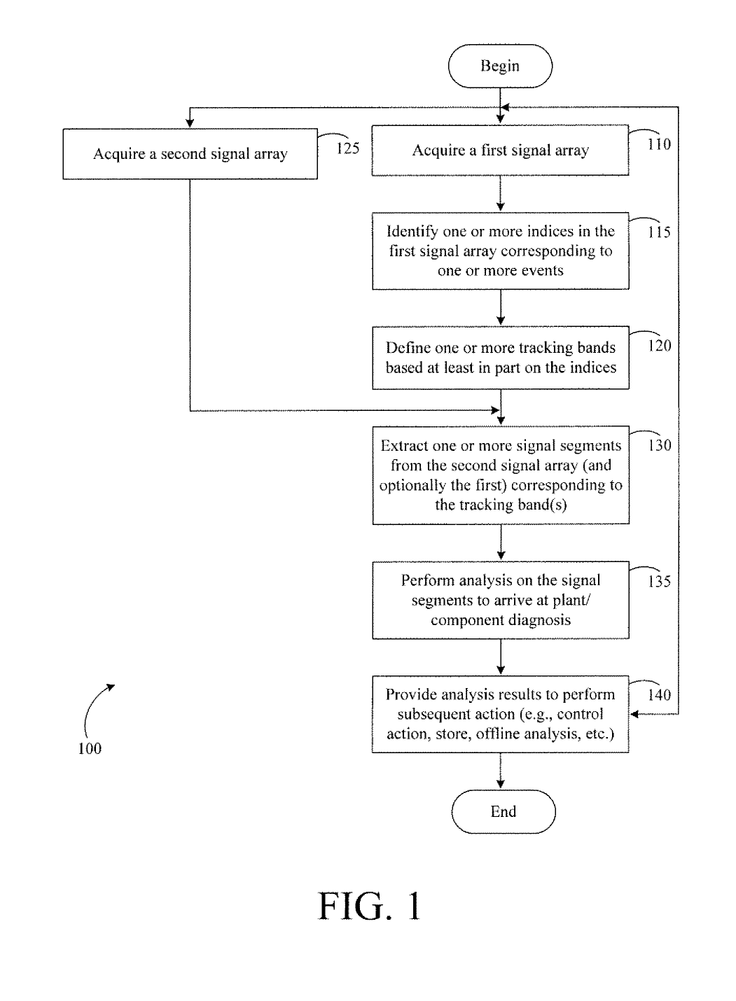

FIG. 1 is a flowchart illustrating an example method 100 for performing segmented signal analysis, according to an embodiment of the invention.

The method 100 can begin at block 110, in which a first signal array is acquired for processing to identify tracking bands to facilitate subsequent analysis. According to various embodiments, the first signal may be any signal used to perform plant control and/or diagnosis operations. For example, the first signal may be a measured signal from a plant operating component (e.g., rotating machinery, compressors, fuel paths, exhaust paths, etc.). The first signal may also be a theoretically modeled signal, such as may be used when modeling plant behavior (e.g., predictive control, alternative control scheme modeling, etc.). In various embodiments, the first signal may be a combination of a measured signal and a modeled signal. Accordingly, as used herein the term “signal array” is not intended to be limited to measured signals but can be any signal represented by a waveform on which further analysis is to be performed. Example signals that may be acquired at block 110 include, but are not limited to, a gas force curve, crosshead acceleration, motor current, displacement probe measurements, time-based curves, any domain or range based relationship, and the like.

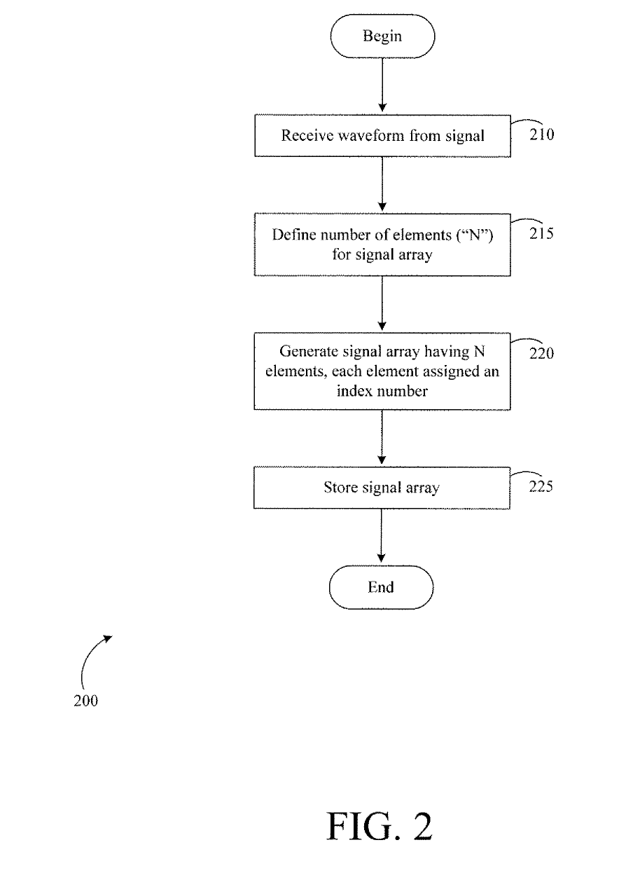

According to one embodiment, the signal acquired at block 110 may already be converted from an analog waveform into an array (e.g., one-dimensional) of discrete values (i.e., digitized). Moreover, it is appreciated that the signal acquired at block 110 may also be conditioned, such as filtered (e.g., bandpass), subjected to a wavelet analysis, or by any other signal processing and/or conditioning techniques as desired for the type of signal acquired and the subsequent analysis to be performed. FIG. 2 illustrates additional detail of the elements that may be performed to digitize an analog waveform into an array of discrete values. It is appreciated, however that, according to one embodiment, the conversion and/or conditioning elements may also be performed as one aspect of block 110.

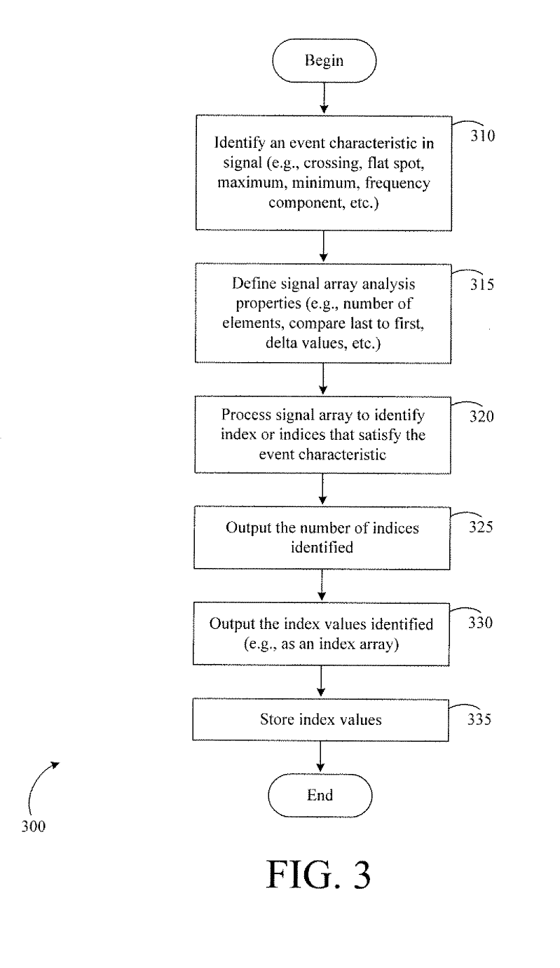

Following block 110 is block 115, in which one or more indices corresponding to one or more events indicated by the first signal array acquired at block 110 are identified. As described above, an event can refer to any characteristic of the signal data that may indicate an event or other behavioral aspect for further analysis. The actual event identified at block 115 depends on the type of the first signal and the underlying measured and/or modeled data. Example events include, but are not limited to, an nth-crossing event (e.g., a zero-crossing event as may occur when gas force curve changes from positive to negative or vice versa), the appearance of a certain frequency component (e.g., for identifying component vibration levels, rubs, or Nx characteristics, etc.), a flat spot in a waveform (e.g., such as on a motor current curve to detect looseness, which can be identified where the derivative of the waveform data equals zero), wavelet analysis on a crosshead acceleration or piston rod waveform, a maximum point, a minimum point, average, ay statistical analysis, and the like. It is appreciated that any number of events or signal characteristics may be identified at block 115, depending upon the application and signal being analyzed. Additional details regarding identifying the indices corresponding to an event are described with reference to FIG. 3.

At block 115, the output generated may be a discrete number for each index identified (e.g., 1, 5, 12, etc.). The value of the number depends upon the manner in which the array is defined, which may depend in part on the type of signal being represented by the array. According to one embodiment, the output generated may be in the form of an index array, such as if multiple event occurrences are identified in the first signal array.

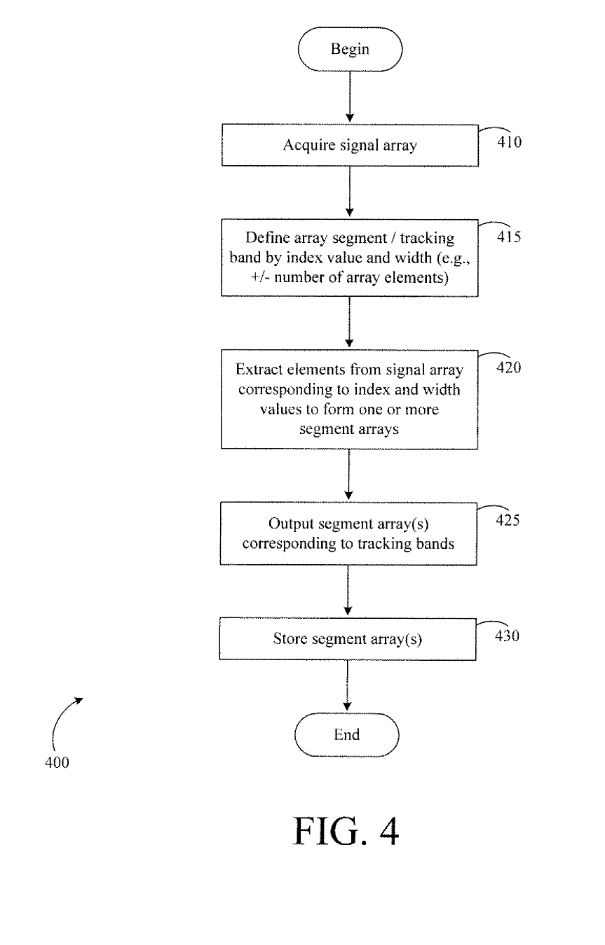

Following block 115 is block 120, in which one or more tracking bands are defined based at least in part on the indices identified at block 115. The term “tracking band” as used herein generally refers to any segment of data elements within an array to be extracted or otherwise processed for further analysis. A tracking band can include any number of data elements, and can be adjustable depending upon the circumstances and the analysis being performed. Thus, after having identified one or more indices in the first signal data array corresponding to events, a tracking band can be identified at block 120 at or around the data elements represented by the index or indices. As a simplified example, if a single index of “5” is identified at block 115 as indicating the event of interest, a tracking band can be identified as the value(s) indicated in the array at the index value of 5 plus a given number on either side of the index (e.g., ±2). In this example, five total elements would be returned from the array—those for elements having an index values=[3, 4, 5, 6, 7]. It is appreciated that the tracking band of segmented data can be identified as large or small as desired. The wider the tracking band the greater amount of data that can be analyzed during the subsequent processing. The tracking band can be statistically determined, or determined by any scientific computing method. Additional details regarding defining the tracking band are described with reference to FIG. 4 when describing segmenting a signal array.

Following block 120 is block 125, in which a second signal array is acquired for analyzing segments corresponding to the tracking band(s) defined at block 120. The second signal may be any additional signal that can aid in plant operation and/or control, and that may represent plant and/or component behavior associated with or represented by the first signal. For example, a second signal may provide additional details of a given component or plant behavior, and when combined with the analysis performed on the first signal, a diagnosis can be performed accordingly. One example of a second signal associated with a first signal can be accelerometer measurements that are analyzed in association with changes in a gas force signal (e.g., as may be performed to identify mechanical looseness and/or failures within a reciprocating compressor stream, such as a loose piston, piston rod, crosshead assembly, crank shaft, suction valve, discharge valve, etc.). Other examples of second signals can include, but are not limited to, stator frame velocity measurements in association with motor current first signals to detect looseness, bearing cap velocity measurements in association with displacement probe signals to detect component rubs, high-resolution signals in association with a first signal event, and the like.

It is appreciated that any combination of second signal and first signal arrays may be analyzed by the example systems and methods described herein, depending upon the desired diagnosis and/or plant operation being performed. In addition, according to various embodiments, the second signal can be any measured signal, theoretically modeled signal, or a combination thereof. Moreover, it is appreciated that the example signals described herein as second signals may instead be analyzed as a first signal to identify the tracking band(s) and the first signal examples may be segmented for subsequent analysis. Thus, while certain examples are provided herein, the order by which the analysis is performed should not be construed as being limiting, and the same or similar segmenting analysis may be performed in a reverse order as related to the type signals acquired.

Similar to that described with reference to the first signal, the second signal may already be converted from a waveform into an array and/or conditioned (e.g., filtered, wavelet analysis, any other signal processing technique, etc.) prior to acquiring it at block 125. However, according to other embodiments, the second signal may be converted into an array and/or conditioned as part of the processing performed at block 125. The details regarding waveform to signal array conversion are described in more detail with reference to FIG. 2.

After having acquired the second signal array at block 125 and defined the tracking bands from the first signal array at block 120, the method continues to block 130. At block 130 the second signal array is processed to extract the signal segments corresponding to the tracking band or bands defined via the analysis of the first signal array. Extracting the tracking band(s) permits more efficiently identifying signal characteristics in the second signal that correspond to the previously identified events in the first signal. Thus, signal data can be segmented for analysis based at least in part on the analysis of the corresponding first signal data, limiting the amount signal data to be analyzed, but also permitting data capture more likely to correspond to the event of interest. The processing performed to segment the data from the second signal array that corresponds to the tracking bands is described with reference to FIG. 4.

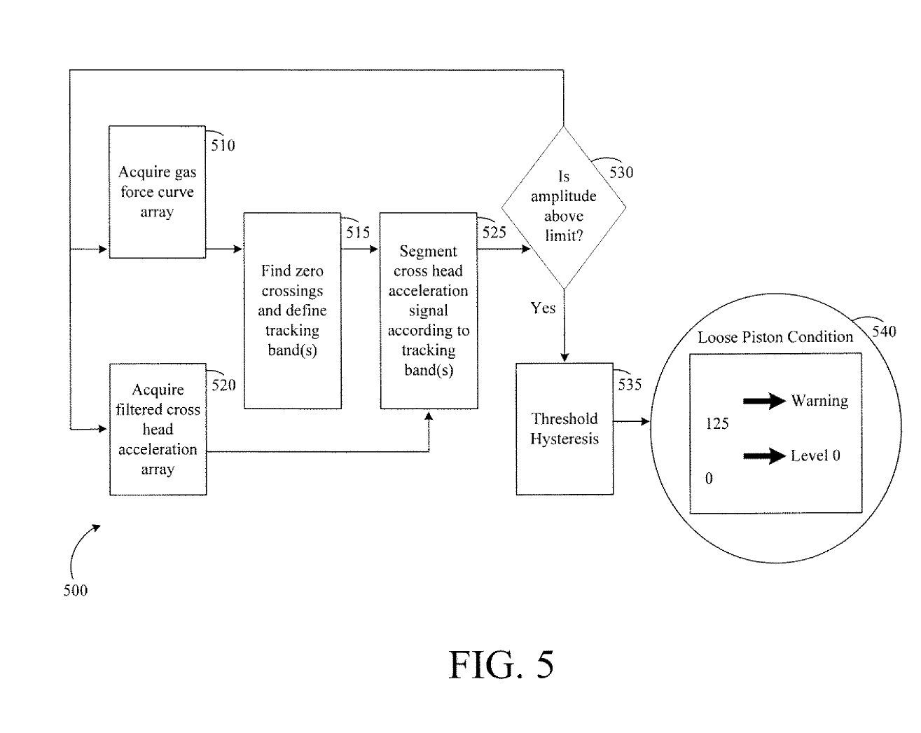

Following block 130 is block 135, in which an analysis may be performed on the segmented data of the second signal that corresponds to the tracking bands, as extracted at block 130. It is appreciated that the analysis performed varies depending upon the signal being analyzed and the diagnosis and/or operation being performed. Based on the analysis performed, it may be determined whether one or more system conditions exist, such as is illustrated by example in FIG. 5. Example analysis includes zero-to-peak, peak-to-peak, average, FFT, wavelets, buffering, waveform reconstruction, statistical, or any scientific computing method to further analyze and make decisions based on the extracted data.

It is further appreciated that, according to one embodiment, the first data signal array can also be segmented according to the tracking bands and analyzed at blocks 130 and block 135, respectively.

After having performed the analysis at block 135 and/or at block 140, the system can be configured to generate any type of control action, store data and corresponding analysis for subsequent, off-line processing, generate reports, and the like.

The method 100 can end after block 140, having performed an analysis on at least the second signal, and optionally the first signal based on the tracking bands identified by processing the first signal to extract data corresponding to the events. It is appreciated that, according to various embodiments, the system can be configured to perform the steps of the method 100 periodically, in a scheduled manner, or constantly, such that after the analysis at block 135 is performed, new first and second signals are acquired, tracking bands re-defined, and the signal(s) reanalyzed. In example embodiments, the diagnostic controller may receive the first and/or the second signals after the associated machine component has completed one or more cycles (e.g., rotations, etc.) before acquiring new signal data.

FIG. 2 is a flowchart illustrating an example method 200 for converting a waveform to an array of discrete waveform samples, according to an embodiment of the invention. As described with reference to FIG. 1 above, the systems and methods described herein perform processing on arrays represented measured and/or modeled signals to permit segmenting the signals to extract portions of interest for further analysis.

The method 200 begins at block 210, in which a waveform is received by the diagnostic system. As described above, the waveform can be any analog waveform that is measured directly in association with plant and/or component operation, a theoretically modeled waveform, or any combination thereof.

Following block 210 is block 215, in which the number of elements (“n”) in the signal array to be generated are defined. According to one embodiment, the number of elements can be considered a sampling rate, such that the analog waveform is digitized or otherwise sampled based on the number of elements defined at block 215. It is appreciated that the number of elements can vary depending upon the underlying signal the waveform represents and the purpose of the diagnostics being performed.

Following block 215 is block 220, in which a signal away is generated having the same number of elements as defined at block 215. According to one embodiment, each element is assigned a corresponding index number (e.g., 0, 1, 2, 3, 4 . . . , etc.). However, according to other embodiments, the index number may be assumed to follow a given convention and not explicitly assigned. Accordingly, the values in the signal array will represent the original waveform values at the discrete points according to the sampling rate. According to one embodiment, the values in the array will have the same engineering units as the original waveform.

Though, according to other embodiments, the diagnostic system can perform a conversion or other conditioning before storing the final values in each element of the signal array, such as may be desired. For example, the values may be normalized, may be filtered, may be subject to wavelet analysis, may be mathematically manipulated (e.g., mathematically adding, subtracting, multiplying, dividing, or performing any other mathematical operations on signal data to arrive at the engineering units desired for subsequent processing and analysis), and the like. It is appreciated that the diagnostic controller can be programmed to perform any conversion or conditioning as desired, depending upon the original waveform and the purpose of the diagnostics being performed.

A simplified example signal array having nine array elements can be represented as follows:
[1, 1.5, 0, −2.5, 6, 5.5, −2, −3, −0.4].
   The index values may be represented as follows:
[0, 1, 2, 3, 4, 5, 6, 7, 8].
   This example signal array can represent an example waveform, such as:
   It is appreciated that this waveform and signal array are provided for illustrative purposes, and that any waveform can be provided and sampled into any number of array elements.

Following block 220 is block 225, in which the generated signal array can be stored. According to one embodiment, the signal array may be stored in memory of the diagnostic system, such as in a database or other computer-readable memory. It is appreciated that the signal array may be stored for a transient period of time, such as if the array is generated during real-time or near real-time diagnostic processing, and/or may be stored for longer durations, such as if asynchronous or off-line processing is performed or when stored for subsequent analysis, hysteresis, and/or historical reporting.

The method may end after block 225, having converted an analog waveform into a signal array for further diagnostic processing.

FIG. 3 is a flowchart illustrating an example method 300 for identifying one or more index values corresponding to the occurrence of an event.

The method 300 begins at block 310, in which an event characteristic is identified. As described above, an event characteristic can be any waveform characteristic that indicates an event that is to be further analyzed by the diagnostic controller. In one example, a waveform representing a gas force curve associated with a compressor may exhibit zero-crossing characteristics that indicate the points along the gas force curve that transition between positive and negative force values. Thus, according to this example, an event characteristic may be any point along the gas force curve that indicates the zero-crossing event (e.g., anywhere the waveform crosses zero). It is appreciated that any number of events, such as, but not limited to, those described herein by example (e.g., the appearance of a frequency component, a fiat spot, any other crossing event, a maximum value, a minimum value, any static value, etc.); and that the zero-crossing event is provided for illustrative purposes only.

Having identified the event characteristic, the diagnostic controller can be programmed to store attributes of the event characteristic that will enable identifying signal array elements satisfying the characteristic during processing. Using the zero-crossing event as an example, one or more of the following attributes can be programmed into the diagnostic controller to permit identifying the zero crossing events: array element at (index)=0; array element at (index—1)>0 and array element at (index)<0; array element at (index—1)<0 and array element at (index)>0; etc. It is appreciated that the attributes associated with a given characteristic event can vary, and are identifiable upon understanding the characteristic event and its impact on the associated waveform.

Following block 310 is block 315, in which one or more analysis properties can optionally be defined for analyzing the signal array when identifying events. Any number of properties can be provided to the diagnostic controller as may be desired to define the array analysis technique used. Example array analysis properties can include, but are not limited to, the number of elements in the array to analyze (e.g., one machine cycle, multiple cycles, etc.), whether to compare the last element of the array to the first (e.g., to aid in identifying an event that may occur at or near the beginning of a machine cycle, etc.), delta values indicating minimum or maximum values to be attained before an event occurrence can be determined (e.g., when determining a zero-crossing event the delta values can be set to ±1, such that the array element value must exceed −1 if crossing into the negative values or exceed 1 if crossing into positive values before a zero-crossing is determined to have occurred). It is appreciated that these analysis properties and associated values may differ depending upon the signal and the purpose of the analysis performed.

Following block 315 is block 320, in which the signal array (e.g., the first signal array acquired at block 110 in FIG. 1) is processed to identify the index values for array elements that satisfy event characteristics within the signal array. As described herein, the event characteristics can vary widely, and thus the methods for identifying the occurrence thereof can also vary.

As a simplified example, a signal array having n elements can be processed sequentially an element at a time to determine whether the event characteristics are satisfied (e.g., attributes associated with events). The diagnostic system can be configured to take into consideration the signal array analysis properties defined at block 315 when processing each element of the signal array. For example, using the example signal array defined above, first signal array [1, 1.5, 0, −2.5, 6, 5.5, −2, −3, −0.4] with index values [0, 1, 2, 3, 4, 5, 6, 7, 8], the index values [2, 4, 6] correspond to element values [0, 6, −2], which in turn indicate zero-crossing events. More specifically, the diagnostic controller can identify array element value of 0 at index=2 as a zero crossing event (assuming the delta value is set to zero such that reaching or crossing the zero axis satisfies the event characteristics). The array element value of 6 at index=4 is identified as a zero crossing event because at index=3 the array element value is negative (−2.5) and at index=3 the array element value is positive (6). The array element value of −2 at index=6 is identified as a zero crossing event because at index=5 the array element value is positive (5.5) and at index=6 the array element value is negative (−2). As can be seen, the diagnostic controller can be programmed to identify the occurrence of a single event characteristic (e.g., zero-crossing) according to a variety of attributes. It is appreciated that this example of identifying zero-crossing events within an array is provided for illustrative purposes, and that any other event characteristic can be identified within an array by performing similar techniques. For example, using the same signal array of [1, 1.5, 0 −2.5, 6, 5.5, −2, −3, −0.4], the diagnostic controller can identify an index value=4 as indicating the occurrence of a maximum event (e.g., array element value of 6) or the index value=7 as indicating the occurrence of a minimum event (e.g., array element value of −3).

Following block 320 is block 325, in which the number of indices identified at block 320 is output. Reference the examples above, in the number of zero-crossing events is three, the number of maximum events is 1, and the number of minimum events is 1. According to various embodiments, the number of indices identified could be expressly output and/or stored, or inferred from the indices identified.

Following block 325 is block 330, in which the index values identified at block 320 are output. According to one embodiment, the index values may also be output as an array comprising the identified index or indices as the element values. Referencing the above examples, the zero-crossing index values may be output as a zero-crossing index array=[2, 4, 5] referencing the signal array element values of [0, 6, −2]. The maximum and/or minimum index values may be output as a maximum index array=[4] and a minimum index array=[7], representing the signal array element values of [6] and [−3], respectively.

At block 335, which follows block 330, the index values can be stored, according to one embodiment. The index values may be stored in memory of the diagnostic system, such as in a database or other computer-readable memory. It is appreciated that the index values may be stored for a transient period of time, such as if the index values are generated during real-time or near real-time diagnostic processing, and/or may be stored for longer durations, such as if asynchronous or off-line processing is performed or when stored for subsequent analysis, hysteresis, and/or historical reporting.

The method 300 can end after block 335, having identified index values corresponding to the occurrence of events in a signal array. The processing performed by the method 300 can be performed while processing a first signal array, such as occurs at block 115 with reference to FIG. 1, to facilitate segmenting a second signal array based on the occurrence of the events identified. It is appreciated, however, that the steps described with reference to the method 300 are not limited to determining events in a first signal array, but similar processing may be performed on any array to identify the occurrence of any event or other signal characteristics.

FIG. 4 is a flowchart illustrating m example method 400 for extracting array segments from a given signal array, for example, when extracting array segments from a second signal array corresponding to a tracking band defined based on the occurrence of events in a first signal array, such as is described with reference to FIG. 1.

The method 400 begins at block 410, in which a signal array is acquired for segmentation. As described above, the signal array can be any signal array, such as the second signal array corresponding to a waveform associated with a plant and/or component condition that may also be represented via the first signal, in which an event characteristic is identified.

Following block 410 is block 415, in which one or more array segments (also referred to herein as a “tracking band”) can be defined based on one or more index values identified as representing the occurrence of an event. For example, an index array can be identified as described with reference to FIG. 3 and the tracking bands defined that correspond to each index value identified.

According to one embodiment, the tracking bands can be defined as having a width, which may be defined by a number of array elements occurring before and/or after each index value identified. For example, if index values are identified (e.g., based on the first signal array) as=[3, 12, 54], and a bandwidth is to include 2 additional array elements on each side of the index, the tracking bands would be represented by index values=[1-5, 10-14, 52-56], whereby the first range represents a first tracking band, the second range represents a second tracking band, and the third range represents a third tracking band each corresponding to the occurrence of events in the other signal (or, in some embodiments, the same signal). In another example, if a bandwidth of zero is desired, the tracking band will be defined as corresponding only to the indices previously identified (e.g., [3, 12, 54]). It is appreciated that any number of tracking bands can be defined (e.g., a single tracking band or any number of multiple tracking bands) and that the bandwidth can be defined as any number of additional elements.

Following block 415 is block 420, in which elements from the signal array acquired at block 4 10 are extracted that correspond to the tracking band(s) defined at block 415. According to one example, the diagnostic controller can extract the signal array element values and generate one or more segment arrays, each of which correspond to the tracking bands. As an example, a second signal array can be defined as=[5, 10, 15, 20, 25, 30, 35, 40] (having index values=[0, 1, 2, 3, 4, 5, 6, 7]) with tracking bands defined as a single index value=3 (e.g., as defined by the method described with reference to FIG. 3), but having a bandwidth of ±2 elements. Accordingly, by this example, at block 420 the diagnostic controller would identify a single segmented array with five element values=[10, 15, 20, 25, 30]. In another example, if multiple indices are identified as defining the tracking bands, such as index values=[1, 4] and having a bandwidth of ±1, two separate segmented arrays would equal=[5, 10, 15] and [20, 25, 30]. It is appreciated that the diagnostic controller can be programmed to provide any variety of array definitions, and that these examples are provided for illustrative purposes. It is further appreciated that the term “extracted” as used herein is not intended to be limited to actually removing array segments and/or storing new segments in memory, but can generally refer to identifying such array segments to enable subsequent operation thereon.

Following block 420 is block 425 in which the one or more segmented array(s) are output that correspond to the defined tracking bands. For example, the segmented array(s) can be output for subsequent analysis by the diagnostic controller, as is described with reference to block 135 in FIG. 1. According to various embodiments, the diagnostic controller may further output the number of valid elements identified in the signal array and generated into a segmented array(s) that satisfy the tracking bands as defined. This output may be useful because, under certain circumstances, the segmented array(s) may not be as “wide” or otherwise include as many elements as are defined by the tracking bandwidth, such as may occur if the tracking band index value is located at or near the end of the signal array sample and the bandwidth is greater than the number of remaining array elements. Accordingly, the number of elements in the segmented array may provide beneficial information to the diagnostic controller and/or operator, such as to determine whether additional data acquisition and/or signal arrays could be analyzed to compliment the signal already analyzed and provide a more complete representation of plant and/or component health.

Following block 425 is block 430, in which the segmented array(s) can be stored, according to one embodiment. The segmented array(s) may be stored in memory of the diagnostic system, such as in a database or other computer-readable memory. It is appreciated that the segmented array(s) may be stored for a transient period of time, such as if the arrays are generated during real-time or near real-time diagnostic processing, and/or may be stored for longer durations, such as if asynchronous or off-line processing is performed or when stored for subsequent analysis, hysteresis, and/or historical reporting.

The method 400 may end after having extracted one or more segmented arrays from a signal array corresponding to tracking bands that may indicate the occurrence within the signal array of one or more events.

FIG. 5 is a flowchart illustrating one example method 500 for performing plant and/or component diagnostics using dynamic segmented signal analysis in a manner similar to that described with reference to FIG. 1. This example illustrates a gas force curve array as a first signal array and a crosshead accelerometer signal array as a second signal array that are analyzed to identify relatively loose piston conditions in a compressor, for example. This example is provided for illustrative purposes only, and is not intended to be limiting.

The method 500 begins at block 510, in which a gas force curve array is acquired by the diagnostic controller. The gas force curve waveform from which the associated array is converted can represent changing gas pressures and associated forces within a compressor. It may be desirable to monitor the pressure and force changes within a compressor to identify zero-crossing events—the time at which the force changes from a positive force to a negative force—because this signifies an event in which mechanical failure may be more likely to occur (e.g., loose pistons, rods, etc.). It is appreciated that the gas force curve array is acquired in a manner similar to that described with reference to block 110 in FIG. 1 and with reference to FIG. 2.

Following block 510 is block 515, in which zero-crossing events are identified within the gas force curve array. As part of identifying the zero-crossing events, the index corresponding to the one or more array elements indicating the event are identified, such as by an index array. Moreover, the index values are used to define one or more tracking bands. It is appreciated that identifying the indices associated with the zero-crossing events and defining corresponding tracking bands can be performed in a manner similar to that described with reference to blocks 115 and 120 in FIG. 1 and with reference to FIGS. 3 and 4.

Following block 515 is block 520, in which a filtered crosshead acceleration array is acquired. The filtered crosshead acceleration array may be a signal array (like the second signal array in FIG. 1) converted from an accelerometer output waveform. According to various embodiments, the accelerometer can be used to identify vibrations, oscillations, and the like, which may also be useful to analyze to indicate mechanical failures or loosened components. As illustrated at block 520, the crosshead acceleration signal array can be filtered according any desired technique prior to being acquired by the diagnostic controller for analysis. It is appreciated that the crosshead acceleration array is acquired in a manner similar to that described with reference to block 125 in FIG. 1 and with reference to FIG. 2.

Following block 520 is block 525, in which the crosshead acceleration array can be segmented according to the tracking band(s) identified that correspond to the zero-crossing events of the gas force curve in a manner similar to that described with reference to FIG. 4,

Following block 525 are blocks 530, 535, and 540, in which an analysis is performed on at least the tracking band segment(s) of the crosshead acceleration signal array extracted at block 525. According to the example illustrated in FIG. 5, the diagnostic controller can determine whether a certain predefined threshold, such as an amplitude, or other limit, whether statistically or scientifically computed using numerical methods, is exceeded and/or perform other threshold or hysteresis analysis. Moreover, as indicated by the arrow returning from block 525, the method 500 can be repeated for subsequent cycles to provide dynamic tracking band definition and component diagnosis.

The method can end after block 540, having analyzed a gas force curve to identify more pertinent segments of acceleration data for subsequent analysis. Accordingly, by identifying zero-crossing events in the gas force curve, the diagnostic machine can more efficiently segment out the data from the accelerometer signal that corresponds to the zero-crossing events, and thus more likely to contain data indicating a failure. As is shown in FIG. 5, this example method 500 may be performed to indicate relatively loose piston conditions upon identifying crosshead acceleration data that is above the predetermined amplitude.

As generally described herein, analyzing a first signal directly corresponding to the system operation (whether it be measured and/or modeled) to identify the signal segments to be analyzed, creates a technical effect of providing diagnostic methods and systems that can adapt to and account for differences in plant and/or component operation that likely will occur over time. For example, as plant machines continue to operate, the machine health degrades, plant operations change, plant environments change, each of which in turn causes differences in measured and/or modeled signals. Conventional methods typically define signal segments statically at a given point in time for given machine conditions (e.g., warm-up, at load. etc.), which cannot easily account for changing conditions without re-defining the static signal segments. Moreover, due to the various possible combinations that may affect the machine signal, advanced planning via these conventional methods require unwieldy numbers of conditions to be accounted for when programming the diagnostic systems. In contrast, certain embodiments of the systems and methods described herein can create a technical effect that permits accounting for the changing environment conditions dynamically in real-time or near real-time by defining the relevant signal segments based on the an actual and/or modeled signal representing the plant conditions at or near the time the diagnostic is being performed. Accordingly, plant and/or component diagnosis can be greatly simplified, at least due to the fact that not every possible or likely plant condition that would effect the signals has to be considered in advance when programming the diagnosis systems.

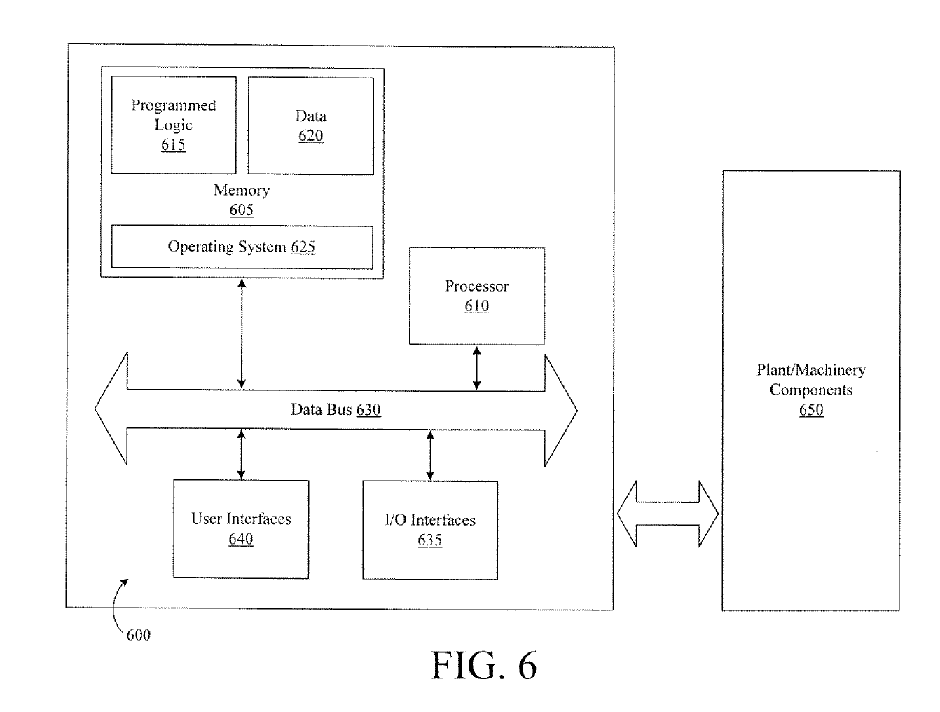

FIG. 6 illustrates a block diagram an example diagnostic controller 600, which may be used to at least partially carry out one or more of the example plant and/or component 650 diagnostic methods described herein. More specifically, one or more diagnostic controllers 600 may carry out the execution of the diagnostic methods described herein. Each diagnostic controller 600 may include a memory 605 that stores programmed logic 615, for example the software that performs at least some of the diagnostic and signal segmentation functions described above with reference to FIGS. 1-5, and may store data 620, such as signal array data, index arrays, tracking bands, and the like. The memory 605 also may include an operating system 625. A processor 610 may utilize the operating system 625 to execute the programmed logic 615, which may include computer-executable instructions for performing some or all of the methods described herein, and in doing so, also may utilize the data 620. A data bus 630 may provide communication between the memory 605 and the processor 610. Users may interface with the diagnostic controller 600 via a user interface device(s) 640 such as a keyboard, mouse, control panel, or any other devices capable of communicating data to and from the diagnostic controller 600. The diagnostic controller 600 may be in communication with one or more plant and/or machinery components, such as with monitoring systems and measuring hardware and/or software, control systems, modeling systems, and the like, via an I/O interface 635. Though not shown, the diagnostic controller 600 can comprise multiple controllers and/or can communicate with other memories and/or controllers for accessing distributed data and/or distributing processing and/or providing redundant processing.

It is further appreciated that the diagnostic controller 600 illustrated in and described with reference to FIG. 6 is provided by example only and is not intended to be limiting. For example, any other programmable component may be used to implement at least in part the systems and methods described herein. Example components include, but are not limited to, a special purpose computer, special purpose hardware-based computer, a digital signal processor (DSP), a microcontroller, a discrete logic circuit, or any other programmable data processing apparatus.

The application references block diagrams of systems, methods, apparatuses, and computer program products according to at least one embodiment described herein. It will be understood that at least some of the blocks of the block diagrams, and combinations of blocks in the block diagrams, respectively, may be implemented at least partially by computer-executable instructions. These computer-executable instructions may be loaded onto a computer, such as, but not limited to, a special purpose computer, special purpose hardware-based computer, a digital signal processor (DSP), a microcontroller a discrete logic circuit, or any other programmable data processing apparatus to produce a machine, such that the instructions which execute on the computer or other programmable data processing apparatus create means for implementing the functionality of at least some of the blocks of the block diagrams, or combinations of blocks in the block diagrams discussed in detail in the descriptions below.

These computer-executable instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer-executable instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based, or programmable consumer electronics, mini-computers, mainframe computers, etc.

Application programs that are components of the systems and methods described herein may include routines, programs, components, data structures, etc. that implement certain abstract data types and perform certain tasks or actions. In a distributed computing environment, the application program (in whole or in part) may be located in local memory, or in other storage. In addition, or in the alternative, the application program (in whole or in part) may be located in remote memory or in storage to allow for circumstances where tasks are performed by remote processing devices linked through a communications network.

Many modifications and other embodiments of the exemplary descriptions set forth herein to which these descriptions pertain will come to mind having the benefit of the teachings presented in the foregoing descriptions and the associated drawings. Thus, it will be appreciated the invention may be embodied in many forms and should not be limited to the exemplary embodiments described above. Therefore, it is to be understood that the invention is not to be limited to the specific embodiments disclosed and that the modification and other embodiments are intended to be included within the scope of the appended claims. Although specific terms are employed herein, they are used in a generic and descriptive sense only and not for purposes of limitation.

The claimed invention is:

1. A method for diagnosing system conditions, comprising:
acquiring a first signal array and a second signal array;
defining at least one event characteristic;
identifying at least one index in the first signal array corresponding to the at least one event characteristic;
defining at least one tracking band based at least in part on the identified at least one index;
extracting at least one segment array from the second signal array corresponding to the at least one tracking band;
analyzing the at least one segment array extracted from the second signal array; and
providing the results of the analysis of the at least one segment array extracted from the second signal array.

2. The method of claim 1, wherein acquiring the first signal array comprises acquiring a first measured or modeled signal and generating the first signal array comprising segments corresponding to the first measured or modeled signal.

3. The method of claim 2, further comprising associating an index with each of the segments in the first signal array.

4. The method of claim 1, wherein the at least one event characteristic comprises at least one of: (a) an n-crossing event; (b) a frequency component; (c) a flat spot in a waveform; (d) a maximum value in an array; (e) a minimum value in an array; or (f) an average value in an array.

5. The method of claim 1, wherein the first signal corresponds to a gas force curve, and wherein the at least one event comprises a zero-crossing event.

6. The method of claim 1, wherein the first signal corresponds to a vibration measurement, and wherein the at least one event comprises a frequency component.

7. The method of a claim 1, wherein identifying the at least one index in the first signal array comprises identifying a plurality of index values and defining an output array comprising the plurality of index values.

8. The method of claim 1, wherein defining the at least one tracking band further comprises defining a width value for the at least tracking band, wherein the width value indicates the number of data elements on either side of each of the at least one index that comprise the at east one tracking band.

9. The method of claim 1, wherein acquiring the second signal array comprises acquiring a second measured signal and generating the second signal array comprising segments corresponding to the second measured signal.

10. The method of claim 9, further comprising associating an index with each of the segments in the second signal array.

11. A diagnostic system, comprising:
a memory operable to store computer-executable instructions;
a communication interface operable for receiving signal data; and
at least one processor in communication with the memory and the communication interface, and operable to access the memory to execute the computer-executable instructions to:
acquire a first signal array and a second signal array;
define at least one event characteristic;
identify at least one index in the first signal array corresponding to the at least one event characteristic;
define at least one tracking band based at least in part on the identified at least one index;
extract at least one segment array from the second signal array corresponding to the at least one tracking band; and
analyze the at least one segment array extracted from the second signal array.

12. The system of claim 11, wherein the at least one processor is further operable to execute the computer-executable instructions to:
acquire, via the at least one communications interface, a first measured or modeled signal; and
generate the first signal array comprising segments corresponding to the first measured or modeled signal.

13. The system of claim 12, wherein the at least one processor is further operable to execute the computer-executable instructions to associate an index with each of the segments in the first signal array.

14. The system of claim 11, wherein the at least one event characteristic comprises at least one of: (a) an n-crossing event; (b) a frequency component; (c) a flat spot in a waveform; (d) a maximum value in an array; or (e) a minimum value in an array; or (f) an average value in an array.

15. The system of claim 11, wherein the first signal corresponds to a gas force curve, and wherein the at least one event comprises a zero-crossing event.

16. The system of claim 11 wherein the first signal corresponds to a vibration measurement, and wherein the at least one event comprises a frequency component.

17. The system of a claim 11, wherein, when identifying the at least one index in the first signal array, the at least one processor is further operable to execute the computer-executable instructions to:
identify a plurality of index values; and
define an output array comprising the plurality of index values.

18. The system of claim 11, wherein the at least one processor is further operable to execute the computer-executable instructions to define a width value for the at least tracking band, wherein the width value indicates the number of data elements on either side of each of the at least one index that comprise the at east one tracking band.

19. The system of claim 11, wherein the at least one processor is further operable to execute the computer-executable instructions to:
acquire, via the at least one communications interface, a second measured signal;
generate the second signal array comprising segments corresponding to the second measured signal; and
associate an index with each of the segments in the second signal array.

20. A diagnostic system, comprising:
a memory operable to store computer-executable instructions;
a communication interface operable for receiving signal data; and
at least one processor in communication with the memory and the communication interface, and operable to access the memory to execute the computer-executable instructions to:
acquire a first signal array and a second signal array;
define at least one event characteristic corresponding to the first signal array;
identify at least one index in the first signal array that displays the at least one event characteristic; and
analyze at least one segment from the second signal array corresponding to the at least one index identified in the first signal array; and
determine that at least one system condition exists based on analyzing the at least one segment.
